(19) United States
(12) Patent Application Publication
(10) Pub. No.: US 2020/0405562 A1
(43) Pub. Date: Dec. 31, 2020

(54) Massager

(71) Applicant: Fuji Medical Instruments Mfg. Co., Ltd., Osaka (JP)

(72) Inventor: Shogo KODAMA, Osaka (JP)

(73) Assignee: Fuji Medical Instruments Mfg. Co., Ltd., Osaka (JP)

(21) Appl. No.: 16/802,999

(22) Filed: Feb. 27, 2020

(30) Foreign Application Priority Data
Jun. 26, 2019 (JP) 2019-118219

(51) Int. Cl. A61G 15/12; A61H 7/00; A61G 15/00

(52) U.S. Cl. CPC A61G 15/12; A61H 7/007; A61G 15/007; A61H 2203/0431; A61H 2201/1638; A61H 2201/0103; A61H 2201/5097; A61H 2205/06

(57) ABSTRACT

A massager includes an arm treatment portion which administers treatment on an arm of a treated person and an accommodation portion capable of accommodating a portable electronic terminal. The arm treatment portion includes a recessed portion which accommodates a forearm and a hand of the treated person. The accommodation portion is provided in a front part of the recessed portion.

### RELATED APPLICATIONS

This nonprovisional application claims priority under 35 U.S.C. § 119(a) to Patent Application No. 2019-118219 filed in Japan on Jun. 26, 2019, the entire contents of which are hereby incorporated by reference.

### BACKGROUND OF THE INVENTION

### 1. Field of the Invention

The present invention relates to a massager provided with an arm treatment portion.

### 2. Description of the Related Art

Examples of conventional massagers include chair-type massagers provided with a container pocket which accommodates a remote controller (see, for example, paragraph [0081] and FIG. 1 of Japanese Patent Application published as No. 2004-202020).

In recent years, portable electronic terminals such as smartphones have been increasingly spreading, and thus, it is conceivable that most treated persons carry their portable electronic terminals in pockets of their clothes on their way to where a massage chair is placed. If a treated person keeps his/her portable electronic terminal in a pocket of his/her clothes while receiving treatment, the portable electronic terminal could interfere with the treatment. To prevent this, it is advised for treated persons to take their portable electronic terminals out of pockets of their clothes before receiving treatment.

The massage chairs disclosed at the URL below are provided with, in addition to a container pocket which accommodates a remote controller, a multi-purpose pocket which can accommodate an article such as a portable electronic terminal. The multi-purpose pocket saves a treated person the trouble of finding a place to put his/her portable electronic terminal.

URL:https://www.fujiiryoki.co.jp/product/massagechair/asIs1/func.html

Unfortunately, however, the multi-purpose pocket, being provided on an exterior side face of the massage chair, does not exist within a range that a treated person can naturally reach when sitting down in, or standing up form, the massage chair. As a result, the treated person feels it troublesome to put or take his/her portable electronic terminal in or out of the multi-purpose pocket.

Furthermore, to put a portable electronic terminal in the multi-purpose pocket means to put it outside the massage chair, and thus the treated person may become anxious that the portable electronic terminal might accidentally pop out of the multi-purpose pocket to fall to the floor, which prevents the treated person from receiving treatment in a relaxed state.

### SUMMARY OF THE INVENTION

An object of the present invention is to provide a massager capable of reducing stress on a treated person caused in connection with what to do with a portable electronic terminal.

A massager disclosed herein includes an arm treatment portion which administers treatment on an arm of a treated person, and an accommodation portion capable of accommodating a portable electronic terminal. Here, the arm treatment portion includes a recessed portion which accommodates a forearm and a hand of the treated person, and the accommodation portion is provided in a front part of the recessed portion.

The significance and effects of the present invention will be further clarified by the descriptions of embodiments below. Here, it should be understood that the following embodiments are merely an example of how the present invention can be implemented, and thus the significance of the present invention and the significance of terms describing constituent elements thereof are not limited in any way by those described in the following embodiments.

### BRIEF DESCRIPTION OF THE DRAWINGS

FIG. 1 is a perspective view of a massager according to an embodiment;

FIG. 2 is a schematic sectional view of an arm treatment portion;

FIG. 3 is a schematic top view of the arm treatment portion;

FIG. 4 is a schematic top view of an arm treatment portion according to a first modified example;

FIG. 5 is a schematic top view of an arm treatment portion according to a second modified example;

FIG. 6 is a schematic top view of an arm treatment portion according to a third modified example; and

FIG. 7 is a schematic top view of an arm treatment portion according to a fourth modified example.

### DESCRIPTION OF EMBODIMENTS

### 1. Embodiments

Hereinafter, illustrative embodiments of the present invention will be described in detail with reference to the accompanying drawings.

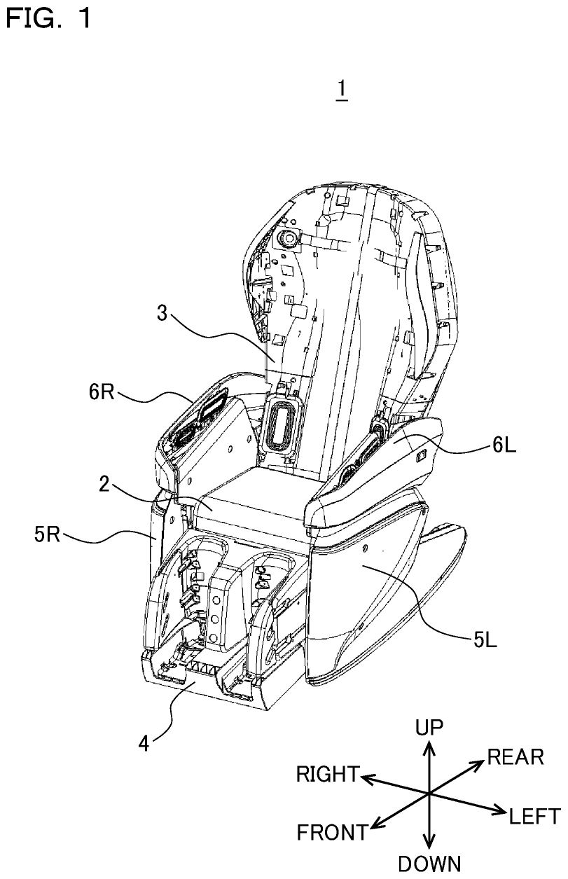

FIG. 1 is a perspective view of a massager 1 according to one embodiment (hereinafter referred to as “the massager 1”). FIG. 1 illustrates only such parts as constitute the framework of the massager 1.

In the following description, different sides are referred to as follows. The term “front” is used to indicate the front side as seen from a treated person seated in the massager 1 when a later-described backrest portion 3 is not reclined. The term “rear” is used to indicate the rear side as seen from a treated person seated in the massager 1 when the backrest portion 3 is not reclined. The term “upper” is used to indicate the upper side (head side) as seen from a treated person seated in the massager 1 when the backrest portion 3 is not reclined. The term “lower” is used to indicate the lower side (leg side) as seen from a treated person seated in the massager 1 when the backrest portion 3 is not reclined. The term “right” is used to indicate the right side as seen from a treated person seated in the massager 1 when the backrest portion 3 is not reclined. The term “left” is used to indicate the left side as seen from a treated person seated in the massager 1 when the backrest portion 3 is not reclined.

The massager 1 is a chair-type massager that includes a seat portion 2 and a backrest portion 3. The massager 1 further includes an ottoman 4, a pair of, namely left and right, base portions 5L and 5R, and a pair of, namely, left and right, arm treatment portions 6L and 6R.

The seat portion 2 supports the buttocks and the thighs of a treated person.

The backrest portion 3 supports the lower back and the back of the treated person. The backrest portion 3 is rotatable about a reclining rotation axis extending along the left-right direction. That is, the backrest portion 3 is inclinable rearward with respect to the seat portion 2. The backrest portion 3 is provided with a massage unit (not shown) having treating elements. The massage unit is guided by a guide rail (not shown) provided in the backrest portion 3 to ascent or descend in the longitudinal direction of the backrest portion 3. Here, the guide rail may be extended further to a rear part of the seat portion 2 so that the massage unit can ascend or descent along the longitudinal direction of the seat portion 2 and of the backrest portion 3. The massage unit includes the treating elements, a kneading driving mechanism driving the treating elements to perform kneading operation, and a pounding driving mechanism driving the treating elements to perform pounding operation.

The ottoman 4 accommodates the lower legs and the feet of the treated person. The ottoman 4 is fitted to the upper front end of a frame member supporting the seat portion 2, so as to be rotatable about a rotation axis extending in the left-right direction.

The ottoman 4 is provided with an air bag. As the air bag inflates and deflates, massage is administered to the lower legs and the feet of a treated person.

The ottoman 4 can be provided with any treating means other than an air bag, or with no treating means at all, unlike in the present embodiment.

The base portion 5L is provided to stand on the left of the seat portion 2, and supports the arm treatment portion 6L. The base portion 5R is provided to stand on the right of the seat portion 2, and supports the arm treatment portion 6R. Accordingly, the arm treatment portion 6L is arranged on the upper left of the seat portion 2, and the arm treatment portion 6R is arranged on the upper right of the seat portion 2.

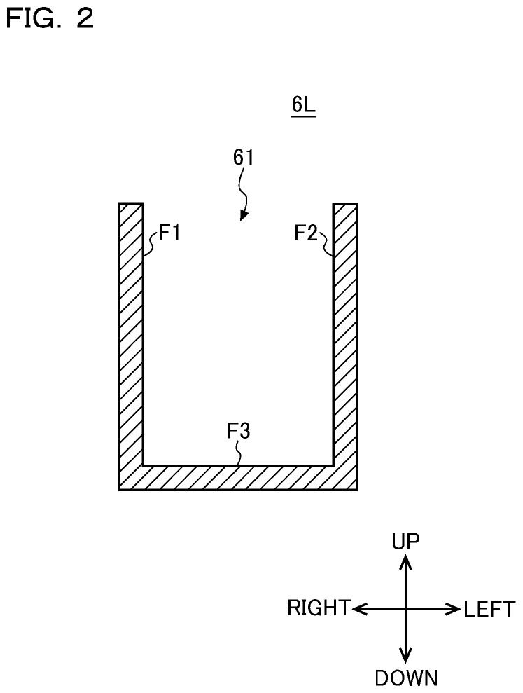

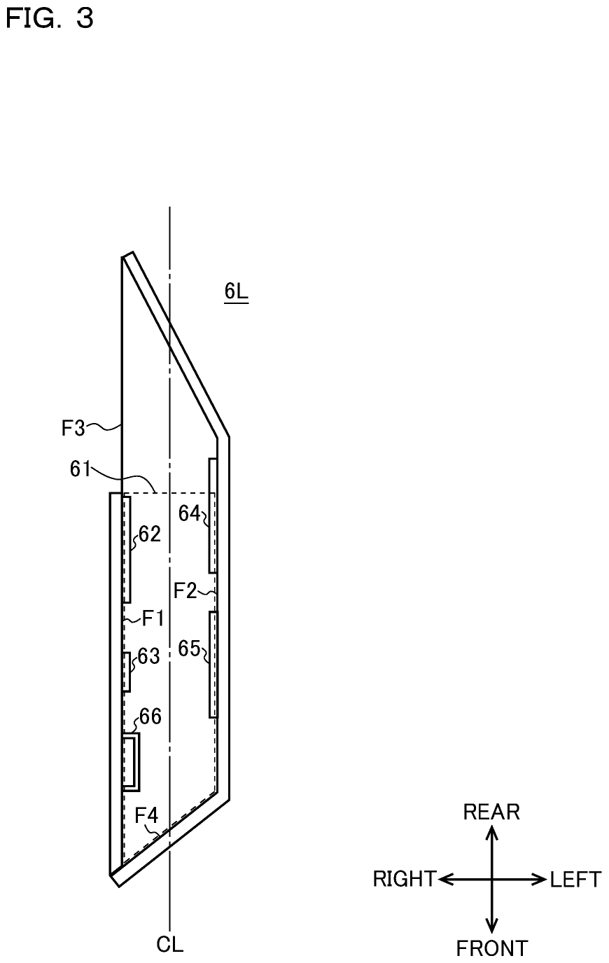

Next, the arm treatment portion 6L will be described. FIG. 2 is a schematic diagram showing a section obtained by cutting the arm treatment portion 6L at its center in the front-rear direction with a virtual plane perpendicular to the front-rear direction. FIG. 3 is a schematic top view of the arm treatment portion 6L. The arm treatment portion 6R is shaped left-right symmetrical to the arm treatment portion 6L, except that the arm treatment portion 6R does not include an accommodation portion 66.

The arm treatment portion 6L includes a recessed portion 61 which accommodates the left forearm and the left hand of the treated person. The recessed portion 61 is depressed downward. The recessed portion 61 includes an inner side face F1, an outer side face F2, and a lower face F3. The front end of the recessed portion 61 is blocked up by a front-side side face F4, and the rear end of the recessed portion 61 is open.

On the inner side face F1, air bags 62 and 63 are provided, and air bags 64 and 65 are provided on the outer side face F2. As the air bags 62 to 65 inflate and deflate, massage is administered to the left forearm and the left hand of the treated person. FIG. 3 illustrates the air bags 62 to 65 in a deflated state. The arm treatment portion 6L is not limited to a configuration capable of administering massage all over the left forearm and the left hand of the treated person, but may be configured to be capable of administering massage at least to part of the left forearm of the treated person.

The treatment that the arm treatment portion 6L administers to the left forearm and the left hand of the treated person is not limited to massage; it can instead be any treatment using a physical means. Accordingly, the treatment that the arm treatment portion 6L administers to the left forearm and the left hand of the treated person may be, for example, treatment in which heat is applied to the left forearm and the left hand, or may be treatment in which an electrical stimulus is applied to the treated part. The arm treatment portion 6L may be configured as, for example, a treating element, an air bag, a vibrating element, a heater, an electrode pad, or the like used singly or in a combination of two or more of them.

In a front part of the arm treatment portion 6L, the accommodation portion 66 is provided. In the present embodiment, the accommodation portion 66 is provided on the inner side face F1. The front part of the arm treatment portion 6L is defined as such part of the arm treatment portion 6L as is located anterior to the center of the arm treatment portion 6L in the front-rear direction.

In the present embodiment, the accommodation portion 66 is provided in a region that does not overlap with a treatment region of the arm treatment portion 6L (the treated part of the treated person pressed by the air bags 62 to 65 in the inflated state) either in the left-right direction or in the up-down direction. This helps prevent a portable electronic terminal from interfering with treatment.

The accommodation portion 66 is structured to be capable of accommodating a portable electronic terminal such as a smartphone. In the present embodiment, used as the accommodation portion 66 is a pocket having an opening in its upper part.

Being provided in the front part of the arm treatment portion 6L, the accommodation portion 66 exists within a range naturally reachable for the treated person with his/her left hand when he/she puts or takes his/her left forearm and left hand in or out of the recessed portion 61 of the arm treatment portion 6L. Accordingly, the treated person can put or take his/her portable electronic terminal in or out of the accommodation portion 66 without feeling troublesomeness. Furthermore, the treated person puts his/her portable electronic terminal inside the arm treatment portion 6L, and thus, even if it accidentally pops out of the accommodation portion 66, the risk of its falling to the floor becomes low. Thus, the treated person can receive treatment in a relaxed state. As a result, stress on the treated person caused in connection with what to do with his/her portable electronic terminal is reduced.

There are more right-handers than left-handers, and right-handers hold their portable electronic terminals with their left hands and operate them with their right hands, and thus, it is preferable, as in the present embodiment, to provide the accommodation portion 66 in a front part of the arm treatment portion 6L, not in a front part of the arm treatment portion 6R.

Here, the accommodation portion 66 may be provided not in the front part of the arm treatment portion 6L but in the front part of the arm treatment portion 6R, although this arrangement will force a right-hander to shift his/her portable electronic terminal from his/her left hand to his/her right hand. Or, for convenience to both right-handers and left-handers, the accommodation portion 66 may be provided one in the front part of each of the arm treatment portions 6L and 6R.

The height (the length in the up-down direction) of the accommodation portion 66 is preferably shorter than the heights of commonly used portable electronic terminals. With this structure, when a portable electronic terminal is put in the accommodation portion 66, the upper part of the portable electronic terminal projects from the accommodation portion 66, and this makes it easy to take his/her portable electronic terminal out of the accommodation portion 66.

The accommodation portion 66 is located, in the left-right direction, closer to the seat portion 2 (see FIG. 1) than the left-right center CL of the recessed portion 61. In other words, in a case where an arm of the treated person is located outside his/her body, the accommodation portion 66 is provided, in the left-right direction, closer to the inside of the treated person than the left-right center CL of the recessed portion 61. With this arrangement, the treated person can easily seize his/her portable electronic terminal from the accommodation portion 66. If, unlike in the present embodiment, the accommodation portion 66 is located closer to the side opposite from the seat portion 2 than the center CL, the treated person needs to twist his/her wrist to seize his/her portable electronic terminal from the accommodation portion 6, and thus it is difficult for him/her to take hold of his/her portable electronic terminal.

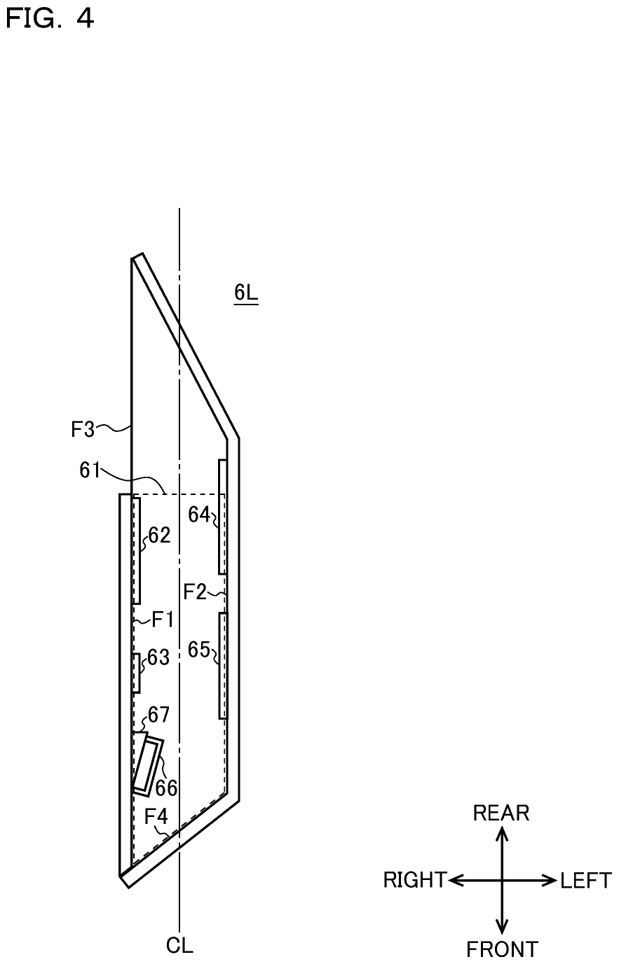

Here, instead of the arrangement of the accommodation portion 66 in the present embodiment, the arrangement shown in FIG. 4 may be adopted such that, when the portable electronic terminal is accommodated in the accommodation portion 66, it is positioned such that part thereof closer to the front is farther away from the left-right center CL of the recessed portion 61. With this arrangement, the treated person can seize the portable electronic terminal from the accommodation portion 66 with his/her fingers naturally bent at the third joints (the joints at the roots of the fingers), and thus the treated person can seize the portable electronic terminal from the accommodation portion 66 more easily. In a modified example shown in FIG. 4, between the inner side face F1 and the accommodation portion 66, a base 67 is provided. The base 67 is a member for changing the arrangement of the accommodation portion 66 from the arrangement shown in FIG. 3.

### 2. Modified Example

It should be understood that the above embodiments are examples in all respects and are not intended to limit the scope of the present invention, that the technological scope of the present invention is not indicated by the above descriptions of the embodiments but by the claims, and that all modifications within the scope of the claims and the meaning equivalent to the claims are covered.

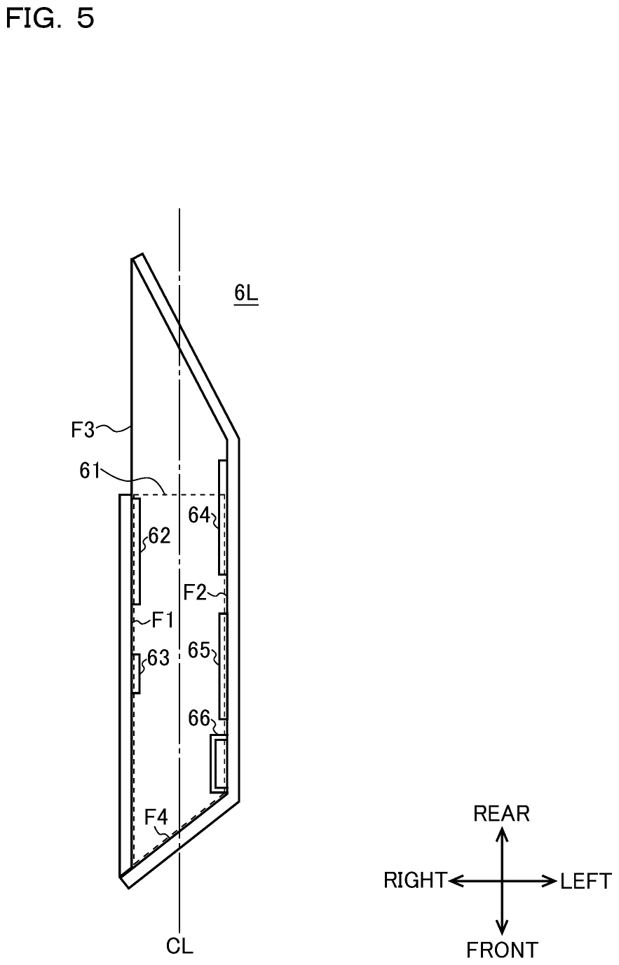

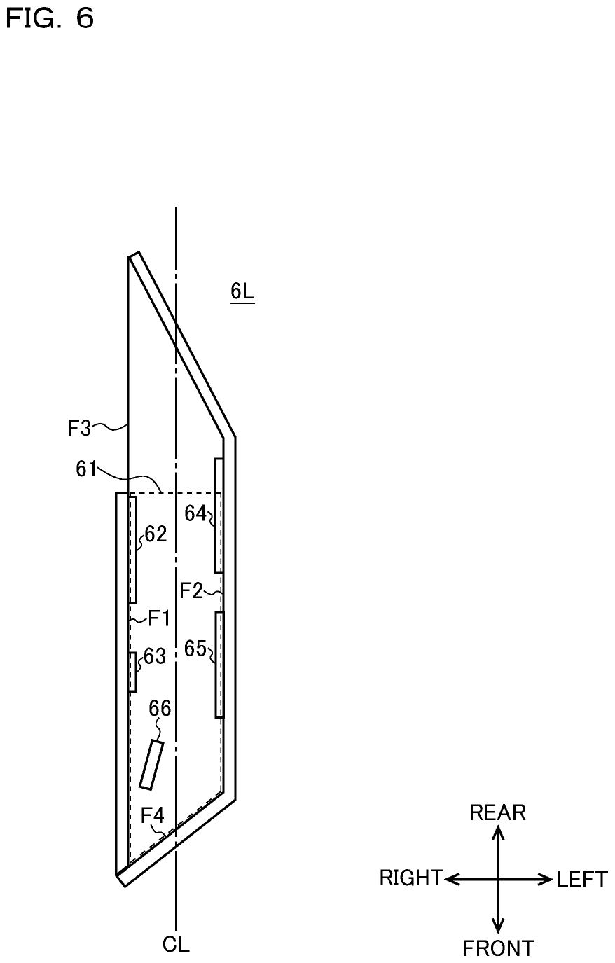

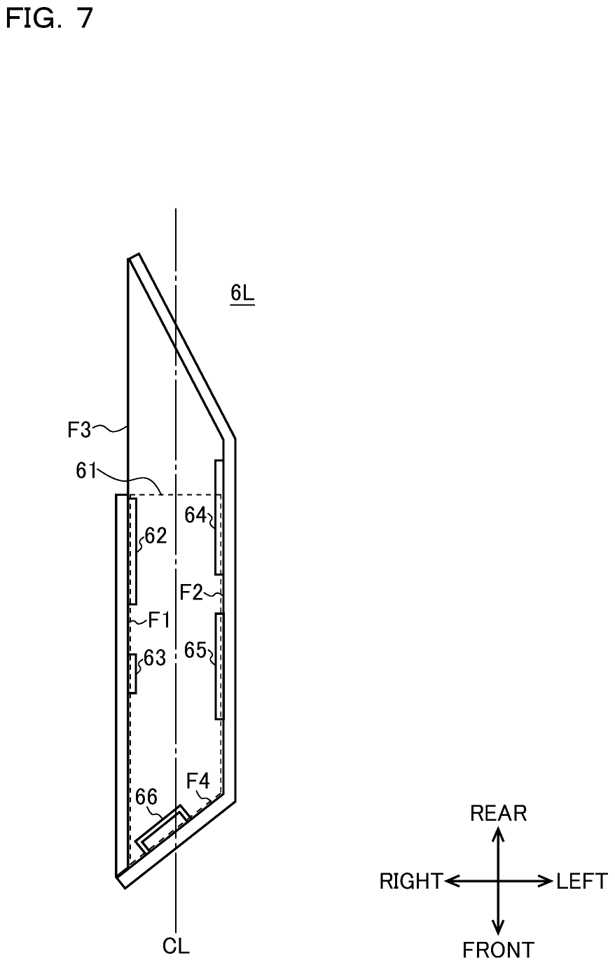

In the embodiments described above, the accommodation portion 66 is provided on the inner side face F1, but instead, as shown in FIG. 5, the accommodation portion 66 may be provided on the outer side face F2, or as shown in FIG. 6, the accommodation portion 66 may be provided on the lower face F3, or as shown in FIG. 7, the accommodation portion 66 may be provided on the front side face F4.

In the configurations shown in FIGS. 5 and 7, a pocket that has an opening in its upper part, for example, can be used as the accommodation portion 66. In the configuration shown in FIG. 6, a bottomed slot, for example, can be used as the accommodation portion 66.

In the case of using a bottomed slot as the accommodation portion 66, the height (the length in the up-down direction) of the accommodation portion 66 is designed to be shorter than the heights of commonly used portable electronic terminals. With this arrangement, the portable electronic terminal is accommodated in the accommodation portion 66 with its upper part projecting from the accommodation portion 66, and thus the portable electronic terminal can be prevented from sinking below the lower face F3.

In the embodiments discussed above, the recessed portion 61 which accommodates the left forearm and the left hand of a treated person and the recessed portion which accommodates the right forearm and the right hand of the treated person are recessed portions depressed downward, but instead, the recessed portion 61 which accommodates the left forearm and the left hand of a treated person may be a recessed portion depressed leftward, and the recessed portion which accommodates the right forearm and the right hand of the treated person may be a recessed portion depressed rightward. In this case, the accommodation portion 66 can be provided on the lower face which is perpendicular to the up-down direction. Or, the recessed portion 61 which accommodates the left forearm and the left hand of the treated person may be a recessed portion depressed rightward, and the recessed portion which accommodates the right forearm and the right hand of the treated person may be a recessed portion depressed leftward. In this case as well, the accommodation portion 66 can be provided on the lower face which is perpendicular to the up-down direction.

The massager 1 may include a charger which charges a portable electronic terminal accommodated in the accommodation portion 66. The charging by the charger may be whichever of non-contact charging and contact charging. In a case where the charger performs contact charging, a contact point for charging can be provided in the accommodation portion 66.

The massager 1 may include a communication portion which communicates with a portable electronic terminal accommodated in the accommodation portion 66. The communication by the communication portion may be whichever of wireless communication and wired communication. In a case where the communication portion performs wired communication, a connector or the like physically connected to the portable electronic terminal for communication can be provided in the accommodation portion 66.

In the embodiments discussed above, the massager 1 is a chair-type massager, but the present invention is applicable also to any massager other than chair-type massagers. For example, the present invention may be applied to bed-type massagers.

### 3. Overview

According to what is disclosed herein, a massager includes an arm treatment portion which administers treatment on an arm of a treated person and an accommodation portion capable of accommodating a portable electronic terminal, the arm treatment portion includes a recessed portion which accommodates a forearm and a hand of the treated person, and the accommodation portion is provided in a front part of the recessed portion (a first configuration).

In the massager having the first configuration, the accommodation portion may be provided in a region that does not overlap with a treatment region of the arm treatment portion either in a left-right direction or in an up-down direction (a second configuration).

In the massager having the first configuration or the second configuration, the recessed portion may accommodate a left forearm and a left hand of the treated person (a third configuration).

In the massager having any one of the first to third configurations, in a case where an arm of the treated person is located outside a body of the treated person, the accommodation portion may be provided, in a left-right direction, closer to an inside of the treated person than a left-right center of the recessed portion (a fourth configuration).

In the massager having the fourth configuration, when the portable electric terminal is accommodated in the accommodation portion, the portable electric terminal may be positioned such that part thereof closer to a front is farther away from the left-right center of the recessed portion (a fifth configuration).

What is claimed is:

1. A massager comprising:
a treatment portion which administers treatment on an arm of a treated person; and
an accommodation portion capable of accommodating a portable electronic terminal,
wherein
the arm treatment portion includes a recessed portion which accommodates a forearm and a hand of the treated person, and
the accommodation portion is provided in a front part of the recessed portion.

2. The massager according to claim 1,
wherein
the accommodation portion is provided in a region that does not overlap with a treatment region of the arm treatment portion either in a left-right direction or in an up-down direction.

3. The massager according to claim 1,
wherein
the recessed portion accommodates a left forearm and a left hand of the treated person.

4. The massager according to claim 2,
wherein
the recessed portion accommodates a left forearm and a left hand of the treated person.

5. The massager according to claim 1,
wherein
in a case where an arm of the treated person is located outside a body of the treated person, the accommodation portion is provided, in a left-right direction, closer to an inside of the treated person than a left-right center of the recessed portion.

6. The massager according to claim 2,
wherein
in a case where an arm of the treated person is located outside a body of the treated person, the accommodation portion is provided, in the left-right direction, closer to an inside of the treated person than a left-right center of the recessed portion.

7. The massager according to claim 3,
wherein
in a case where an arm of the treated person is located outside a body of the treated person, the accommodation portion is provided, in a left-right direction, closer to an inside of the treated person than a left-right center of the recessed portion.

8. The massager according to claim 4,
wherein
in a case where an arm of the treated person is located outside a body of the treated person, the accommodation portion is provided, in the left-right direction, closer to an inside of the treated person than a left-right center of the recessed portion.

9. The massager according to claim 5,
wherein
when the portable electronic terminal is accommodated in the accommodation portion, the portable electronic terminal is positioned such that part thereof closer to a front is more away from the left-right center of the recessed portion.

10. The massager according to claim 6,
wherein
when the portable electronic terminal is accommodated in the accommodation portion, the portable electronic terminal is positioned such that part thereof closer to a front is farther away from the left-right center of the recessed portion.

11. The massager according to claim 7,
wherein
when the portable electronic terminal is accommodated in the accommodation portion, the portable electronic terminal is positioned such that part thereof closer to a front is farther away from the left-right center of the recessed portion.

12. The massager according to claim 8,
wherein
when the portable electronic terminal is accommodated in the accommodation portion, the portable electronic terminal is positioned such that part thereof closer to a front is farther away from the left-right center of the recessed portion.
